(19) United States
(12) Patent Application Publication
(10) Pub. No.: US 2008/0282609 A1
(43) Pub. Date: Nov. 20, 2008

(54) IRRIGATION SHEETS

(76) Inventor: Charles Nelson, Turlock, CA (US)

Correspondence Address: FISH & RICHARDSON PC, P.O. BOX 1022, MINNEAPOLIS, MN, 55440-1022, US

(21) Appl. No.: 11/840,360

(22) Filed: Aug. 17, 2007

Related U.S. Application Data
(60) Provisional application No. 60/823,707, filed on Aug. 28, 2006.

(51) Int. Cl. A01G 25/02

(52) U.S. Cl. 47/48.5

(57) ABSTRACT

Irrigation sheets are disclosed which include a base sheet and one or more tubes extending along the length of the base sheet. Methods of forming and using irrigation sheets are also disclosed.

### TECHNICAL FIELD

This invention relates to irrigation sheets, and to methods of their use in agriculture and gardening.

### BACKGROUND

In many areas of the country, farmers place plastic sheet material over the raised beds prior to planting row crops. This is very typical in the strawberry fields of California for example, as well as water melon fields, and other row crops. Prior to placing the plastic sheet material over the raised bed, the farmer many times will install plastic irrigation drip tubing, which is buried just under the surface, or laying on the surface of the raised bed. The plastic drip tubing is usually laser cut or drilled to allow water to slowly exit the tube, thus irrigating the raised bed and row crop.

### SUMMARY

The present disclosure features irrigation sheets.

In one aspect, the disclosure features an irrigation sheet comprising (a) a base comprising a sheet of plastic material, and (b) a tube, formed integrally with the base, from the sheet of plastic material, and extending along the length thereof; the tube defining a lumen through which fluid can flow along the length of the tube. The tube has a welded area extending lengthwise along the tube, and a plurality of micro-holes extending through the thickness of the tube to allow fluid in the lumen to exit the tube.

Some implementations include one or more of the following features. The irrigation sheet comprises a plurality of tubes extending generally parallel to each other, each of the tubes being formed integrally with the base. The micro-holes are disposed in the welded area. The tube comprises a reinforcing material. The tube has two closed ends, and the irrigation sheet includes a backing tube disposed within the tube to allow a supply connector to be punctured through and secured to the tube.

In another aspect, the disclosure features an irrigation sheet comprising (a) a base comprising a sheet of plastic material having an upper surface and a lower surface, and (b) a tube, extending along the length of the base, the tube defining a lumen through which fluid can flow along the length of the tube. The tube comprises a pair of strips of plastic sheet material, the strips having a width less than that of the base, the strips being bonded to the upper and lower surfaces of the base along the edges of the strips and welded to each other, through the base sheet, inboard of their edges. The tube has a plurality of micro-holes extending through the thickness of the tube along its length to allow fluid in the lumen to exit the tube.

Some implementations include one or more of the following features. The strips have substantially equal width and their edges are generally aligned. The strips are bonded to the base sheet by adhesive bonds.

The disclosure also features methods of forming irrigation sheets.

In one aspect, the disclosure features a method of forming an irrigation sheet comprising: (a) providing a base sheet of plastic material; (b) folding a portion of the base sheet lengthwise about a forming horn to define a tube; (c) welding the folded material to form a weld area; and (d) puncturing micro-holes along the length of the tube.

Some implementations include one or more of the following features. The welding step comprises welding through at least four plies of sheet material. The method further comprises, prior to folding, applying a strip of reinforcing material to the base sheet along the portion to be folded. The method further comprises bonding the strip of reinforcing material to the base sheet to form a pre-form composite. The welding step comprises welding through at least eight plies of sheet material. The puncturing step comprises puncturing the micro-holes in the weld area.

In another aspect, the disclosure features a method of forming an irrigation sheet comprising: (a) providing a base sheet of plastic material having an upper surface and a lower surface; (b) bonding a pair of strips of flexible plastic to the base sheet along the edges of the strips, with one strip being bonded to the upper surface and the other strip being bonded to the lower surface; (c) welding the strips to each other, through the base sheet, inboard of their edges, to define a tube; and (d) forming a plurality of micro-holes along the length of the tube.

The disclosure also features irrigation systems. For example, in one aspect the disclosure features an irrigation system comprising (a) an irrigation sheet comprising (i) a base comprising a sheet of plastic material, and (ii) a tube, extending along the length of the base, the tube defining a lumen through which fluid can flow along the length of the tube, the tube having at least one closed end, a welded area extending lengthwise along the tube, and a plurality of micro-holes extending through the thickness of the tube to allow fluid in the lumen to exit the tube; and (b) a connector system for supplying fluid from a supply to the tube.

Some implementations include one or more of the following features. The connector system comprises a male connector, and a female connector, each of the connectors having a tapered end and a threaded end, the threaded ends configured to be joined to each other in threaded engagement. The connector system comprises a backing tube, positioned within the tube to reinforce the tube, and a drip connector that is punctured through the tube and backing tube.

The disclosure also features methods of using the irrigation sheets disclosed herein to irrigate and fertigate, for example by applying the irrigation sheet to a bed of soil and delivering water or a fertilizer solution through the tube(s).

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of an irrigation sheet in use.

FIG. 2 is an enlarged perspective view of an irrigation sheet according to one implementation.

FIG. 3 is all enlarged perspective view of a connector system for the irrigation sheet of FIG. 2. FIG. 3A is an enlarged end view of the connector system of FIG. 3.

FIGS. 4-4A are side views showing male and female components of an alternate connector system, and FIG. 4B is a side view showing the connector system in use.

FIG. 5 is an enlarged cross-sectional view of the tube portion of an irrigation sheet according to an alternate implementation.

FIG. 6 is an end view of an irrigation sheet having the tube structure shown in FIG. 5, and FIG. 6A is a top view of the irrigation sheet of FIG. 6.

FIG. 7 is an end view, and FIG. 7A is a top view of a pre-form sheet used to form the irrigation sheet shown in FIGS. 6-6A.

FIG. 8 is an enlarged end view of a portion of an irrigation sheet according to another implementation. FIG. 8A is the same view, showing the tube of the irrigation sheet under fluid pressure.

Like reference symbols in the various drawings indicate like elements.

### DETAILED DESCRIPTION

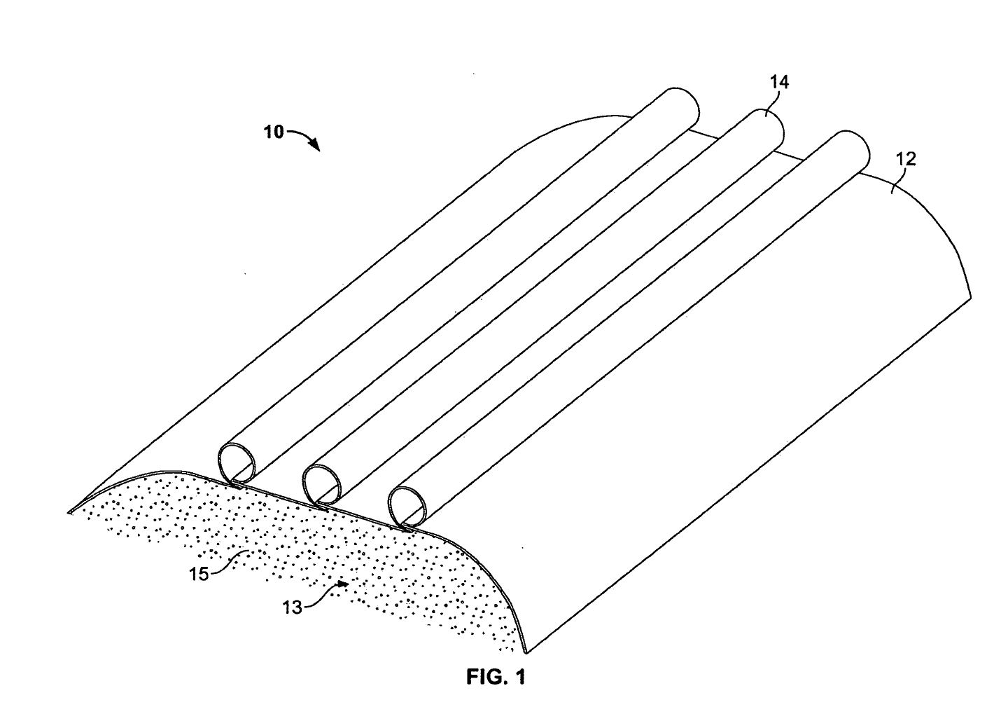

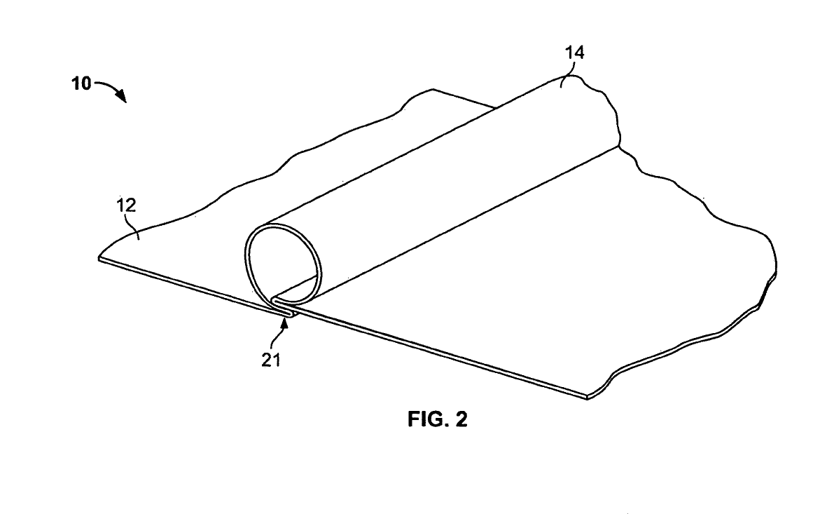

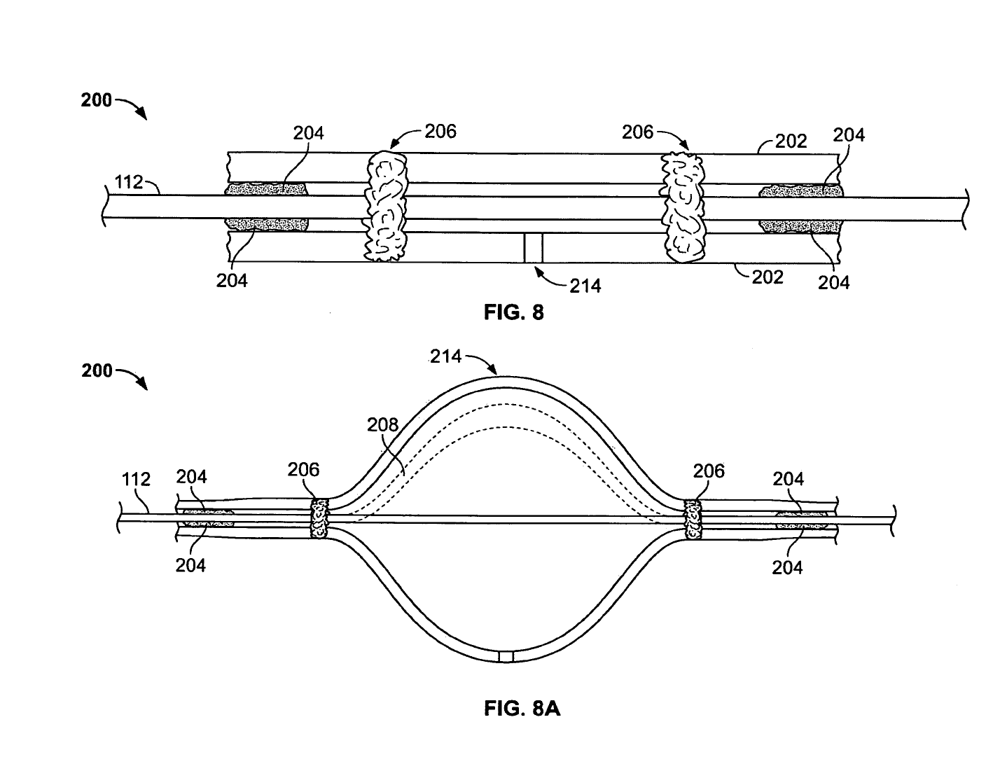

Referring to FIG. 1, an irrigation sheet 10 includes a base sheet 12, and irrigation tubes 14. In several of the implementations disclosed herein, tubes 14 are formed integrally with the base sheet. In these cases, irrigation tubes 14 are formed by folding the base sheet 12 and welding the folded sheet, with or without the provision of a reinforcing strip running along the length of the tube, as shown in FIGS. 2 and 5 and discussed in detail below. In an alternate embodiment, discussed below with reference to FIGS. 8-8A, the tubes are formed by securing strips of plastic lengthwise along the base sheet to the top and bottom surface of the base sheet.

The base sheet may be formed from standard plastic sheet material that is used currently as a mulch on raised beds, for example polyethylene sheeting. Preferably the sheet is relatively thin, e.g., about 0.001″ to 0.003″ thick. The base sheet serves both as a mulch and as a carrier for the irrigation tubes.

As shown in FIG. 1, in use the irrigation sheet 10 may be placed on a raised bed 13, in contact with soil 15. Each irrigation tube generally includes an open end 16, through which water, fertilizer solution, or other liquid media may be delivered. (In some cases, as will be discussed below, a connector may be punctured through the tube along its length, in which case end 16 would be sealed.) Generally, the other end 18 of the tube is sealed, e.g., by heat or ultrasonic welding. If the tube is initially open at both ends, end 18 is sealed or plugged before use so that liquid cannot exit the tube at that end. The tube further includes a plurality of micro-holes (not visible in FIG. 1) positioned along the length of the tube on the side facing the soil 15. The water or other liquid media exits the tube through these holes, providing drip irrigation to the underlying soil. The diameter of the micro-holes will depend on the delivery requirements of water to the raised bed. In some cases, the diameter of the micro-holes may be about 0.003″-0.008″.

In some implementations, the irrigation sheet includes three tubes, e.g., as shown in FIG. 1. The tubes are placed in such a way as to allow the farmer to use one, two or three tubes to irrigate or fertigate the raised bed. For example, the farmer can choose to irrigate on two tubes, and fertilize using the center tube, or to use only one or two of the irrigation tubes.

Water or fertilizer is supplied to the tubes 12 by providing a connector between each tube and a fluid supply. While any desired type of connector may be used, several preferred options will now be discussed.

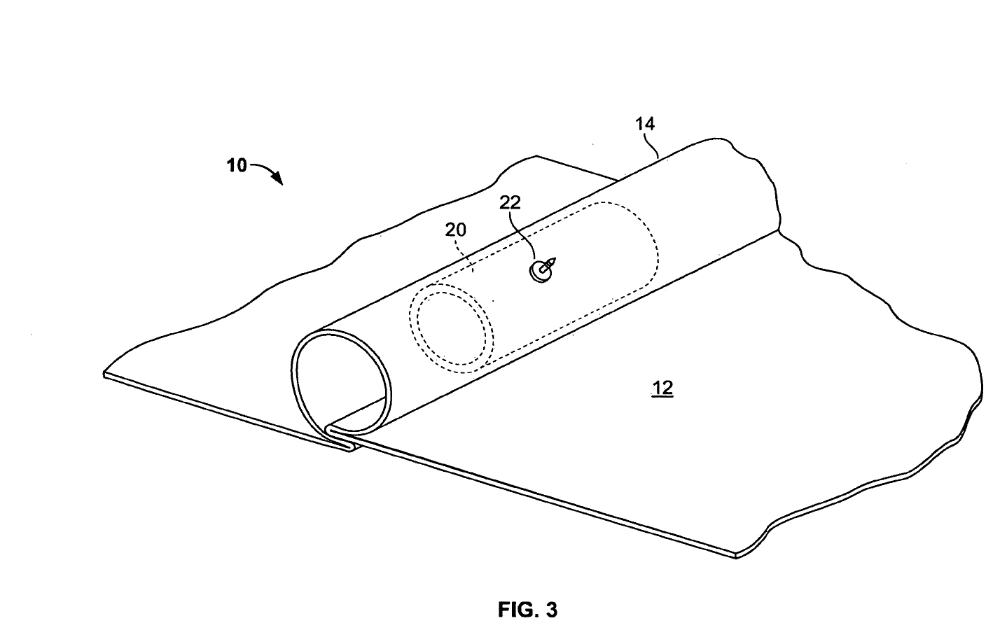

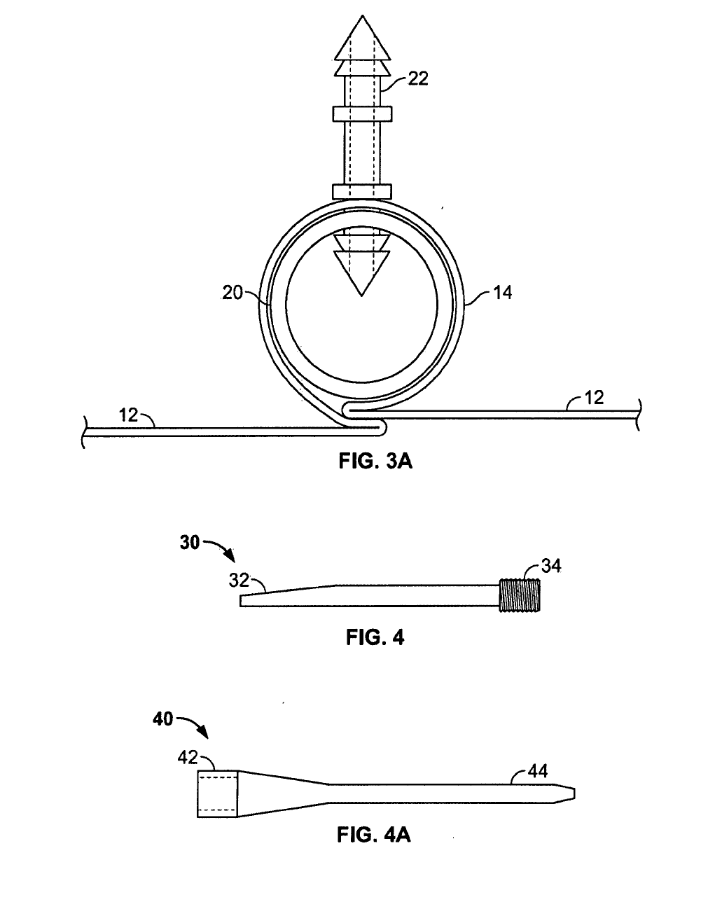

In one implementation, shown in FIGS. 3-3A, a short length of tubing 20, having an OD that is smaller than the ID of the tube, is positioned in the tube near the open end of the tube, forming a backing tube. For a tube that is approximately ¾″ to 1 ″ in diameter, a ½ by 2″ section of tubing is placed inside the formed tube. The short length of tubing may be, for example, conventional flexible drip hose used in drip irrigation systems. The formed tube and backing tube are then punctured using a connector having a sharp end, e.g., using a ¼″ drip line connector 22, so as to tightly seal the outer film material of the formed tube against the inner backing tube and provide a connector to which a supply line may be connected. In this implementation, the open end 16 of the tube will need to be closed. This is easily accomplished by folding the end of the formed tube and clamping it closed, or by sealing the end of the open formed tube, e.g., with heat sealing or ultrasonic welding.

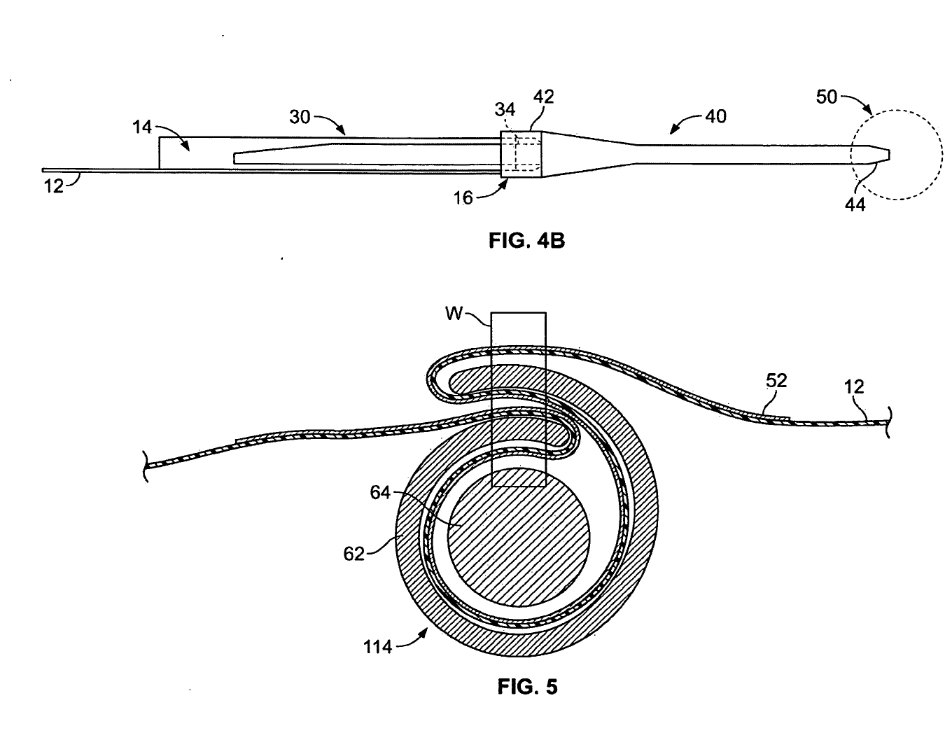

In another implementation, shown in FIGS. 44B, a male/female connector is utilized. The male connector 30 (FIG. 4) will slip inside the open end 16 of the tube 14. The male connector 30 is tapered at a first end 32 so that it inserts into the formed tube, and has a fitting with external threads, e.g., national pipe threads (NPT), at a second end 34. The plastic tube material overlaps the threads of the male connector, as shown in FIG. 4B. A female connector 40 (FIG. 4A) his a first end 42 which includes a fitting with corresponding internal threads, e.g., national pipe threads (NPT). As shown in FIG. 4B, the first end 42 of the female connector 40 is threaded over the second end 34 of the male connecter 30. The first end of the female connector pinches the plastic tube and sheet material against the male connector to create a water-tight seal. The thin tube is captured between the male and female threads in a manner similar to plumber's tape. The opposite end 44 of the female connector 40 is then attached to the water or fertilizer supply line 50 using standard drip connection systems, i.e. a piercing connector which pierces and seals as it is inserted into a larger supply line.

Two rolls of irrigation sheets can also be spliced together by using the connectors similar to those described above. In this case, the female connector has a female fitting on both ends. A male connector is inserted into the tubes of each of the rolls of plastic sheeting, and the female connector is attached between the two male connectors. The same method may be used if there is a failure of a certain portion of the irrigation sheet; the bad section of sheeting is cut away and the splicing connectors are inserted to join two good sections of irrigation sheet.

Referring to FIG. 2, in one implementation the tube 12 is formed by first folding the sheet 12 so that it includes two 180 degree bends, i.e., so that the material is folded over on itself in two areas along the length of the sheet, and then overlapping those two areas and welding the material along the overlap. This forms a welded area 21 that is four layers thick. The micro-holes (not shown) are then formed, preferably in this welded area. The weld may be a single line, or may consist of two or more parallel lines.

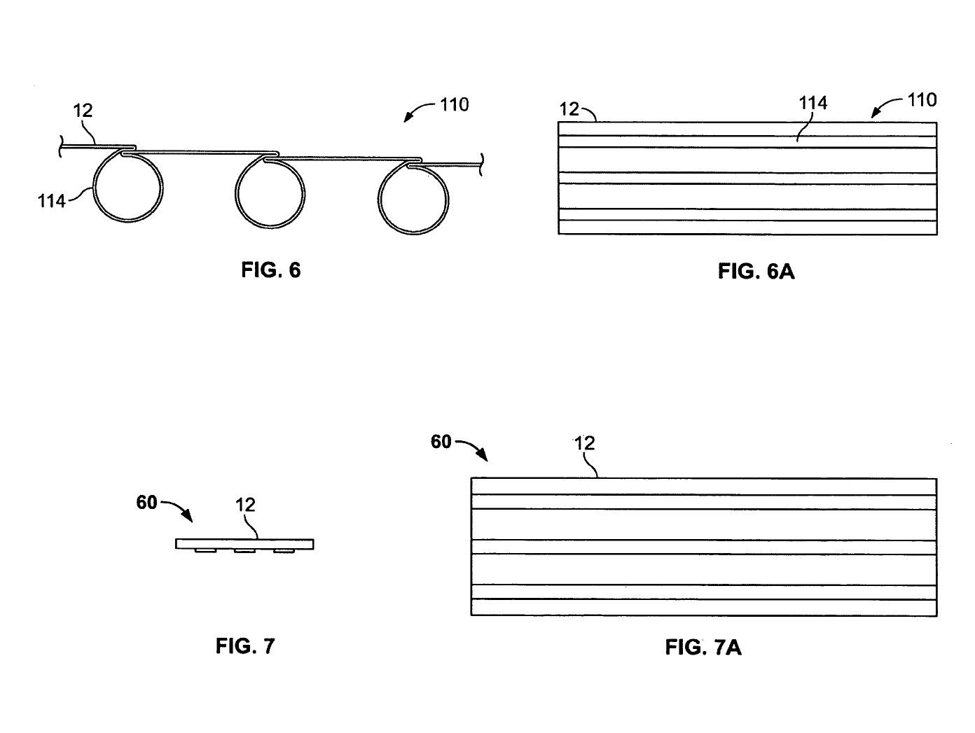

Referring now to FIGS. 5-6A, in an alternate embodiment a tube 114 includes a reinforcing layer 52 to give the tube additional strength. It is noted that the tube 114 is shown in FIG. 5 as it is being formed around a forming horn 62, prior to welding. The reinforcing layer 52 may consist, for example, of a thicker plastic film, a net or scrim material, or a net or scrim material that is captured between two sheets of film. The reinforcing layer should generally be capable of being bonded to the base sheet 12, be weldable, and be capable of imparting some degree of strength to the tube. The reinforcing layer may be bonded to the base sheet so that it is on the exterior of the formed tube, as shown in FIG. 5, or so that it is on the interior of the tube (not shown).

It is particularly preferred in this implementation that the micro-holes be formed in the welded area. If the holes are placed outside the welded area, where there is a gap between the reinforced strip of plastic and the base sheet, the two layers of plastic may separate and fail due to water pressure. In effect, the water pressure could burst the tube from the base plastic sheet. By puncturing the welded area, in which the layers are substantially completely welded as one homogeneous mixture of plastic, and there is minimal chance of layer separation due to water pressure.

The irrigation sheets discussed above with reference to FIGS. 2, 5 and 6-6A may be manufactured as follows. The base plastic sheet 12 is fed into a set of feed rollers that will pull the sheet from the supply roll. For a reinforced tube (FIGS. 5-6A), the reinforced strips are fed from separate rolls and are welded onto the base sheet 12, forming a pre-form composite sheet 60, shown in FIGS. 7 and 7A.

The plastic sheet (with the reinforced strips attached, if they are to be used) is then fed to a tube forming station, and folded, using a forming horn 62 (FIG. 5) that includes a rod 64, to form a tube in the lengthwise direction of the plastic sheet.

The welding process will occur after the tube is formed on the forming horn. A portion of the forming horn 62 is cut away, allowing a welding roll (not shown) to press against the layers of plastic sheeting that forms the tube (eight layers in the case of the reinforced tube, four in the case of the tube shown in FIG. 2). The rod in the center of the forming horn has a Teflon coating and the welding roll presses against this rod, pinching the layers of plastic between the welding roll and rod. As the plastic sheet moves down the forming horn, the welding roll applies heat to the layers of plastic, and the weld is completed in weld area W (FIG. 5).

After the weld is completed, a roller punctures the tube with micro-holes. As discussed above, these holes are preferably punctured directly through the weld.

Referring to FIGS. 8 and 8A, in another implementation, tubes 214 are formed not by folding the base sheet but by welding strips of plastic 202 on both sides of a base sheet 112. In this implementation, it is preferred that the base sheet 112 be very thin, e.g., approximately 0.001″ or thinner. The upper and lower strips of plastic 202 that form the tube are of a thicker, stronger material, e.g., approximately 0.002″ or thicker. Preferably, the micro-holes are formed in the lower strip prior to its being adhered to the base sheet.

To form the tubes in this implementation, the upper and lower strips 202 are bonded to the base sheet, at or adjacent their outer edges, with an adhesive 204. The upper and lower plastic strips are then welded together, forming welds 206. This welding process will in some cases create sufficient heat so that the thin base material 112 will separate from the tube structure. The welds are inboard of the adhesive zone, thereby insuring that the base sheet remains fixed to the formed tube (FIG. 8), via the adhesive.

FIG. 8A shows the tube 214 under fluid pressure. As can be seen in FIG. 8A, the portion 208 of base sheet 112 that is inside the tube 214 will deflect out of the way of the fluid flow, and may separate from the upper and lower plastic strips 202 at the welds 206.

This type of construction allows the stronger plastic strip material to be easily applied in one, two, three, or even four areas of the irrigation sheet simultaneously. In addition, stronger plastic strips of similar thickness can be welded together easily, and also can be adhered easily to the base sheet.

A number of embodiments of the invention have been described. Nevertheless, it will be understood that various modifications may be made without departing from the spirit and scope of the invention. For example, other types of connectors may be used to supply liquid to the irrigation sheet. Accordingly, other embodiments are within the scope of the following claims.

What is claimed is:

1. An irrigation sheet comprising
a base comprising a sheet of plastic material, and
a tube, formed integrally with the base, from the sheet of plastic material, and extending along the length thereof, the tube defining a lumen through which fluid can flow along the length of the tube,
the tube having a welded area extending lengthwise along the tube, and a plurality of micro-holes extending through the thickness of the tube to allow fluid in the lumen to exit the tube.

2. The irrigation sheet of claim 1 comprising a plurality of tubes extending generally parallel to each other, each of the tubes being formed integrally with the base.

3. The irrigation sheet of claim 1 wherein the micro-holes are disposed in the welded area.

4. The irrigation sheet of claim 1 wherein the tube comprises a reinforcing material.

5. The irrigation sheet of claim 1 wherein the tube has two closed ends, and the irrigation sheet includes a backing tube disposed within the tube to allow a supply connector to be punctured through and secured to the tube.

6. An irrigation sheet comprising:
a base comprising a sheet of plastic material having an upper surface and a lower surface, and
a tube, extending along the length of the base, the tube defining a lumen through which fluid can flow along the length of the tube,
the tube comprising a pair of strips of plastic sheet material, the strips having a width less than that of the base, the strips being bonded to the upper and lower surfaces of the base along the edges of the strips and welded to each other, through the base sheet, inboard of their edges,
the tube having a plurality of micro-holes extending through the thickness of the tube along its length to allow fluid in the lumen to exit the tube.

7. The irrigation sheet of claim 6 wherein the strips have substantially equal width and their edges arc generally aligned.

8. The irrigation sheet of claim 6 wherein the strips are bonded to the base sheet by adhesive bonds.

9. A method of forming an irrigation sheet comprising:
providing a base sheet of plastic material;
folding a portion of the base sheet lengthwise about a forming horn to define a tube;
welding the folded material to form a weld area; and
puncturing micro-holes along the length of the tube.

10. The method of claim 9 wherein the welding step comprises welding through at least four plies of sheet material.

11. The method of claim 9 further comprising, prior to folding, applying a strip of reinforcing material to the base sheet along the portion to be folded.

12. The method of claim 11 further comprising bonding the strip of reinforcing material to the base sheet to form a pre-form composite.

13. The method of claim 11 where the welding step comprises welding through at least eight plies of sheet material.

14. The method of claim 11 wherein the puncturing step comprises puncturing the micro-holes in the weld area.

15. A method of forming an irrigation sheet comprising:
providing a base sheet of plastic material having an upper surface and a lower surface;
bonding a pair of strips of flexible plastic to the base sheet along the edges of the strips, with one strip being bonded to the upper surface and the other strip being bonded to the lower surface;
welding the strips to each other, through the base sheet, inboard of their edges, to define a tube; and
forming a plurality of micro-holes along the length of the tube.

16. An irrigation system comprising
an irrigation sheet comprising
a base comprising a sheet of plastic material, and
a tube, extending along the length of the base, the tube defining a lumen through which fluid can flow along the length of the tube,
the tube having at least one closed end, a welded area extending lengthwise along the tube, and a plurality of micro-holes extending through the thickness of the tube to allow fluid in the lumen to exit the tube; and
a connector system for supplying fluid from a supply to the tube.

17. The irrigation system of claim 16 wherein the connector system comprises a male connector and a female connector, each of the connectors having a tapered end and a threaded end, the threaded ends configured to be joined to each other in threaded engagement.

18. The irrigation system of claim 16 wherein the connector system comprises a backing tube, positioned within the tube to reinforce the tube, and a drip connector that is punctured through the tube and backing tube.
